(19) United States
(12) Patent Application Publication
(10) Pub. No.: US 2025/0175751 A1
(43) Pub. Date: May 29, 2025

(54) VOLUME CONTROL SYSTEM AND VOLUME CONTROL METHOD

(71) Applicant: Panasonic Intellectual Property Management Co., Ltd., Osaka (JP)

(72) Inventor: Syuuichi HAGIO, Fukuoka (JP)

(21) Appl. No.: 18/945,206

(22) Filed: Nov. 12, 2024

(30) Foreign Application Priority Data
Nov. 27, 2023 (JP) 2023-200115

(51) Int. Cl. H04R 29/00; H04R 1/10

(52) U.S. Cl. CPC H04R 29/00; H04R 1/1016; H04R 2420/07; H04R 2430/01

(57) ABSTRACT

A volume control system includes two earphones and a wireless terminal. The wireless terminal receives an operation of inputting a volume upper limit value of the earphones and transmits it to the earphones. The earphone increases a current volume in a case where it is determined that the current volume is not the volume upper limit value based on reception of a first continuous operation, and determines whether a second continuous operation is received following the first continuous operation, further determines whether a current volume is the volume upper limit value in a case where it is determined that the second continuous operation is received, increases the current volume in a case that the current volume is not the volume upper limit value, and omit a process of increasing the current volume in a case that the current volume is the volume upper limit value.

### CROSS-REFERENCE TO RELATED APPLICATIONS

This application is based on and claims priority under 35 USC 119 from Japanese Patent Application No. 2023-200115 filed on Nov. 27, 2023, the contents of which are incorporated herein by reference.

### TECHNICAL FIELD

The present disclosure relates to a volume control system and a volume control method.

### BACKGROUND ART

Non-Patent Literature 1 discloses a head mounted display including a display unit for the left eye as well as the right eye that displays videos; a voice output unit that outputs voices associated with the videos; a user operation unit that allows a user to perform an instruction operation on the voices output from the voice output unit; a wearing sensor that detects whether an observer wears a device; and a control unit that controls adjustment of a volume in response to a volume operation via the user operation unit according to a detection result by the wearing sensor.

### CITATION LIST

### Patent Literature

Patent Literature 1: JP2013-93663A

### SUMMARY OF INVENTION

The present disclosure has been made in view of the above-described situation in the related art, and an object of the present disclosure is to provide a volume control system and a volume control method that more effectively prevents an output of a high volume unintended by a user.

The present disclosure provides a volume control system including two earphones each having an input unit capable of receiving a user operation, and a wireless terminal capable of communicating with the earphones. The wireless terminal is configured to receive an operation of inputting a volume upper limit value of the earphones and transmits the volume upper limit value to the earphones. The earphone is configured to store the volume upper limit value, increase a current volume in a case where it is determined that the current volume is not the volume upper limit value based on reception of a first continuous operation in which the user operation by the input unit is continued for a first predetermined time or longer, determine whether a second continuous operation in which the user operation by the input unit is continued for a second predetermined time or longer is received following the first continuous operation, further determine whether a current volume is the volume upper limit value in a case where it is determined that the second continuous operation is received, increase the current volume in a case where it is determined that the current volume is not the volume upper limit value, and omit a process of increasing the current volume in a case where it is determined that the current volume is the volume upper limit value.

Further, the present disclosure provides a volume control method executed by a system. The system includes two earphones each having an input unit capable of receiving a user operation and a wireless terminal capable of communicating with the earphones. The volume control method includes receiving an operation of inputting a volume upper limit value of the earphones and storing the volume upper limit value;
increasing a current volume in a case where it is determined that the current volume is not the volume upper limit value based on reception of a first continuous operation in which the user operation by the input unit is continued for a first predetermined time or longer; determining whether a second continuous operation in which the user operation by the input unit is continued for a second predetermined time or longer is received following the first continuous operation; further determining whether a current volume is the volume upper limit value in a case where it is determined that the second continuous operation is received; increasing the current volume in a case where it is determined that the current volume is not the volume upper limit value; and omitting a process of increasing the current volume in a case where it is determined that the current volume is the volume upper limit value.

These comprehensive or specific aspects may be implemented by a system, a device, a method, an integrated circuit, a computer program, or a recording medium, and may be implemented by any combination of the system, the device, the method, the integrated circuit, the computer program, and the recording medium.

According to the present disclosure, it is possible to more effectively prevent an output of a loud volume unintended by a user.

### BRIEF DESCRIPTION OF DRAWINGS

FIG. 1 is a front view of an earphone according to an embodiment;

FIG. 2 is a rear view of the earphone according to the embodiment;

FIG. 3 is a block diagram of the earphone according to the embodiment;

FIG. 4 is a block diagram of a smartphone according to the embodiment;

FIG. 5 is a diagram illustrating a transition example of a setting screen of a volume upper limit value;

FIG. 6 is a diagram illustrating an example of volume control according to the embodiment;

FIG. 7 is a flowchart illustrating an example of an operation procedure of the earphone according to the embodiment; and

FIG. 8 is a diagram illustrating an example of volume control in the related art.

### DESCRIPTION OF EMBODIMENTS

### Background of Present Disclosure

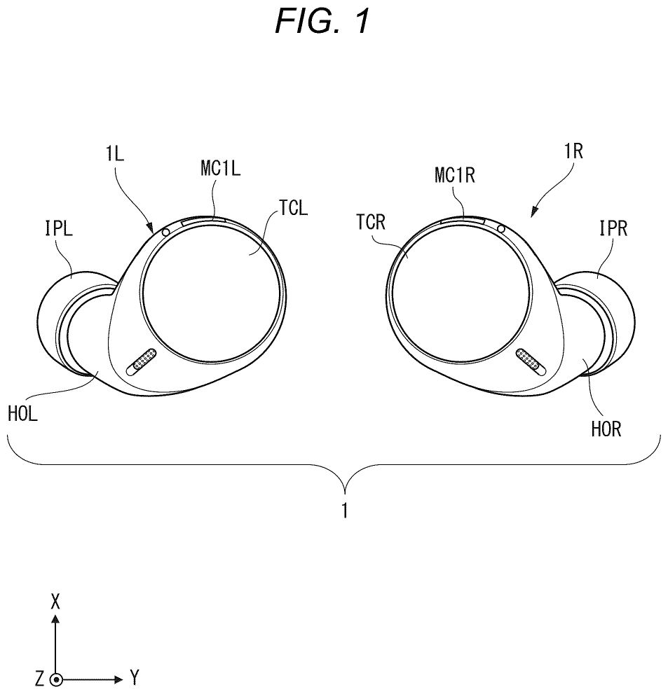

Recently, a style has appeared in which a user inserts completely wireless earphones (hereinafter, referred to as “earphone”), which are also referred to as true wireless stereos (TWS), into both left and right ears for use, respectively. Such an earphone includes a touch sensor (for example, touch sensor TCL illustrated in FIG. 1) capable of receiving a user operation, and can receive an operation of adjusting a volume of an output sound based on the number of times of touches of the touch sensor, a duration of a touch operation, or the like. For example, the earphone can continuously increase the volume of the output sound based on a time of a touch and hold operation of continuously touching the touch sensor detected by the touch sensor.

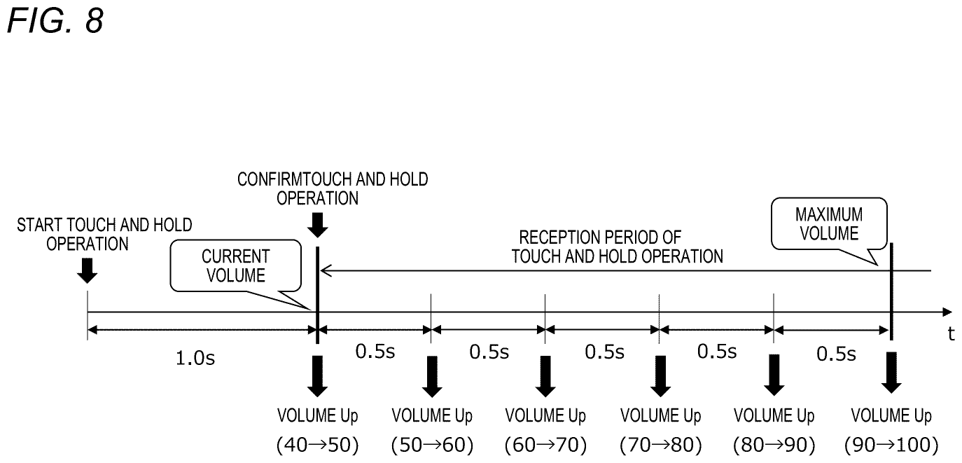

Here, an example of volume control of an earphone in the related art as described above will be described with reference to FIG. 8. FIG. 8 is a diagram illustrating the example of the volume control in the related art. Volume values of “40” to “100” and a time of a touch and hold operation illustrated in FIG. 8 are examples for facilitating the description, and the present disclosure is not limited thereto.

The user starts an operation of the touch sensor at a timing of “start touch and hold operation” illustrated in FIG. 8. In a case where the earphone continues to detect a touch operation on the touch sensor for 1.0 seconds continuously, the earphone determines that the touch operation is a touch and hold operation, and executes initial volume control of increasing the volume from a currently set volume of “40” to a next largest volume of “50”. The earphone executes volume control of increasing the volume by “10” each time the touch and hold operation is continued for 0.5 seconds after the touch and hold operation is confirmed. The earphone repeatedly executes the above-described volume control until the touch and hold operation is completed, and executes the volume control until a maximum value of “100” which is a maximum volume that can be output by the earphone is set.

As described above, in a case where the earphone detects a continuous contact of a finger of the user by the touch sensor, the earphone executes volume control of continuously increasing the volume. Therefore, in a case where the earphone is not accommodated in a cradle after being respectively removed from both ears, for example, are carried in a pocket, a bag, a hand, or the like of the user, and the finger of the user touches the touch sensor, there is a possibility that the earphone receives an operation of adjusting the volume unintended by the user. In such a case, there is a possibility that the earphone outputs a sound at an unintended volume when playing back a sound next time, and the ear of the user is damaged.

Patent Literature 1 discloses a head mounted display capable of preventing a sound of a high volume from being output when the user resumes viewing (when output of sound is resumed) by invalidating an operation of increasing the volume when the user is not wearing the head mounted display, that is, a touch and hold operation for increasing the volume in order to prevent the above-described volume control. However, in Patent Literature 1, there is room for improvement from the viewpoint that it is similarly necessary to protect ears of the user even in the operation of increasing the volume when the user wears the head mounted display.

Hereinafter, embodiments in which a volume control system and a volume control method are specifically disclosed in the present disclosure will be described in detail with reference to the drawings as appropriate. However, more detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

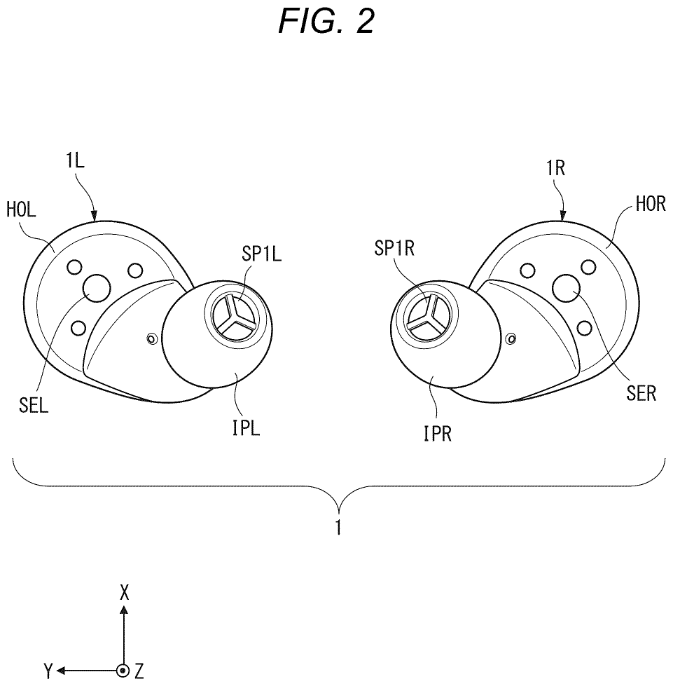

First, a hardware configuration of earphones 1L and 1R will be described with reference to FIGS. 1 and 2. FIG. 1 is a front view of the earphones 1L and 1R. FIG. 2 is a rear view of the earphones 1L and 1R.

For convenience of description, an axis orthogonal to a surface of a touch sensor TCL of the earphone 1L as illustrated in FIG. 1 is defined as a Z-axis. An axis perpendicular to the Z-axis (that is, parallel to touch sensor TCL of earphone 1L) and extending from the earphone 1L to the earphone 1R is defined as a Y-axis. An axis perpendicular to the Y-axis and the Z-axis is defined as an X-axis. In the present embodiment, an orientation of the earphone 1L relating to FIG. 1 is defined as a front view. Expressions relating to these directions are used for convenience of description and are not intended to limit a posture of the structure in actual use. The same applies to other drawings.

In the present embodiment, in a pair of left and right earphones 1L and 1R, configurations of the earphone 1L of a left ear and the earphone 1R of a right ear are the same. Reference numerals of the same components are expressed by adding “L” at the end thereof for the earphone 1L of the left ear, and adding “R” at the end thereof for the earphone 1R of the right ear. In the following description, only the left earphone 1L on one side will be described, and the description of the right earphone 1R on the other side will be omitted.

An earphone 1 includes the two earphones of 1L and IR which are respectively worn in the left ear and the right ear of a user and in which a plurality of earpieces having different sizes are replaceably attached on one end side of each.

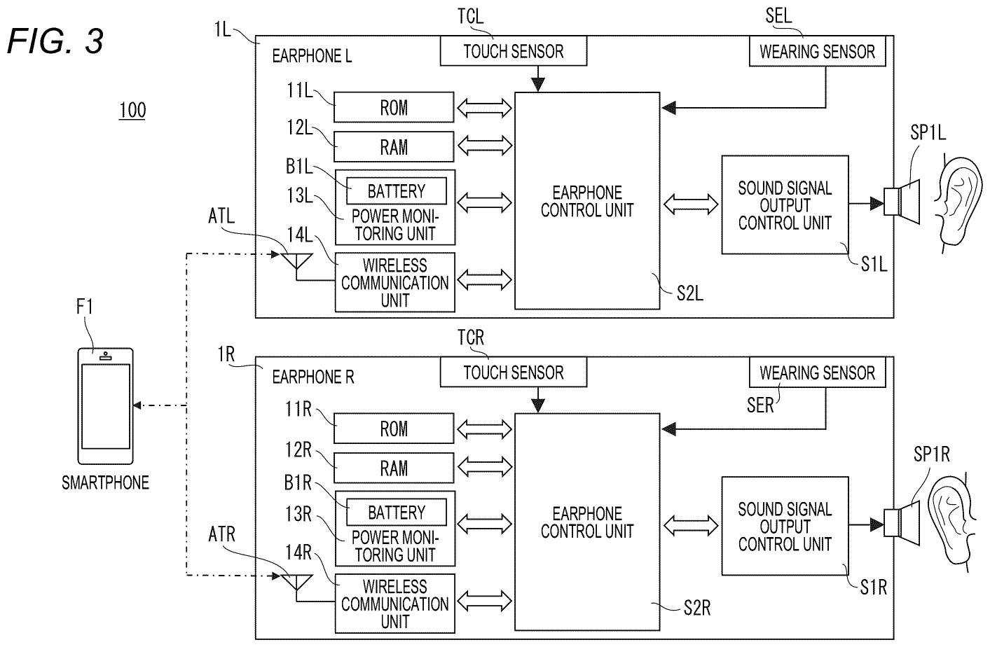

As illustrated in FIG. 1, the earphone 1L is an inner type acoustic device used by being worn in an ear of the user, and receives sound data (for example, music data) transmitted wirelessly (for example, by short-range wireless communication such as Bluetooth (registered trademark)) from an external device such as a smartphone or a portable sound player carried by the user. The earphone 1L acoustically outputs a sound signal based on the received sound data. In addition, the earphone 1L is placed on a cradle (not illustrated) which is a charging cradle when the earphone 1L is not in use. In a case where a battery B1L (FIG. 3) built in the earphone 1L is not fully charged or the like, when the earphone 1L is placed on a predetermined placement position of the cradle, the battery B1L built in the earphone is charged based on power transmitted from the cradle.

A housing HOL is provided as a structural member of the earphone 1L. The housing HOL is made of a composite of materials such as synthetic resin, metal, and ceramic.

The earphone 1L includes an earpiece IPL attached on a main body of the earphone 1L. For example, the earphone 1L is held in a state of being inserted into an inside of an ear canal by the earpiece IPL with respect to the ear of the user, and this held state is a use state of the earphone 1L.

The earpiece IPL is formed by a flexible member such as silicon and is injection-molded with an inner tubular portion (not illustrated) and an outer tubular portion (not illustrated). The earpiece IPL is fixed by being inserted into the attachment cylindrical portion of the housing HOL at the inner tubular portion thereof, and is provided to be replaceable (detachable) with respect to the attachment cylindrical portion of the housing HOL. The earpiece IPL is worn in the ear canal of the user at the outer tubular portion thereof, and is elastically deformed according to a shape of the ear canal on which the earpiece IPL is worn. By this elastic deformation, the earpiece IPL is held in the ear canal of the user. The earpiece IPL has a plurality of different sizes. As for the earpiece IPL, an earpiece of any size among a plurality of earpieces of different sizes is attached to the earphone 1L and worn on the left ear of the user.

The touch sensor TCL is provided on the other end side opposite to the one end side on which the earpiece IPL of the housing HOL is arranged as illustrated in FIG. 1. The touch sensor TCL is a sensor element having a touch sensor function of detecting an input operation (for example, touch operation) of the user. The sensor element is, for example, an electrode of an electrostatic capacitive touch sensor. The touch sensor TCL may be formed as, for example, a circular surface, or may be formed as, for example, an elliptical surface. In addition, the touch sensor TCL may be formed as a rectangular surface.

The earphone 1L executes, based on the touch operation, instructions such as playback, pause, forward a track, and backward a track of sound to an external device, a pairing operation instruction for executing wireless communication such as between Bluetooth (registered trademark) with an external device such as a smartphone, volume control (adjustment) of a sound output from a speaker SP1L, and the like. Here, only the volume control of the sound will be described, and other operations will be omitted.

Specifically, in a case where a touch operation is performed for a long time (so-called touch and hold operation), the earphone 1L executes volume control of increasing the volume of the sound output from the speaker SP1L based on a duration of the touch and hold operation.

As illustrated in FIG. 2, the speaker SP1L is disposed in the attachment cylindrical portion of the housing HOL. The speaker SP1L is an electronic component and acoustically outputs sound data wirelessly transmitted from the external device. Inside the housing HOL, a front surface (in other words, a sound releasing surface of the sound to be acoustically output) of the speaker SP1L is directed toward an attachment cylindrical portion side of the housing HOL covered with the earpiece IPL. Accordingly, the sound acoustically output from the speaker SP1L is further transmitted from an ear hole (for example, external ear portion) of the user to an inner ear and an eardrum inside, so that the user can listen to the sound.

A wearing sensor SEL is implemented by a device that detects whether an earphone is worn in the left ear of the user and is implemented by using, for example, an infrared sensor or an electrostatic sensor. In a case of an infrared sensor, when the earphone 1L is worn in the left ear of the user, the wearing sensor SEL can detect wearing of the earphone 1L in the left ear of the user by receiving infrared rays emitted from the wearing sensor SEL and reflected inside the left ear. In addition, when the earphone 1L is not worn in the left ear of the user, the wearing sensor SEL can detect non-wearing of the earphone 1L in the left ear of the user by not receiving the infrared rays emitted from the wearing sensor SEL without being reflected.

On the other hand, in a case of an electrostatic sensor, when the earphone 1L is worn in the left ear of the user, the wearing sensor SEL can detect wearing in the left ear of the user by determining that a change value of an electrostatic capacity corresponding to a distance to the left ear of the user is larger than a threshold value held by the wearing sensor SEL. In addition, when the earphone 1L is not worn in the left ear of the user, the wearing sensor SEL can detect non-wearing in the left ear of the user by determining that the change value of the electrostatic capacity is smaller than the threshold value held by the wearing sensor SEL. The wearing sensor SEL is provided at a position facing the ear canal when the earphone 1L is inserted into the left ear of the user and on a back surface side of the touch sensor TCL.

Next, a block diagram of the earphone will be described with reference to FIG. 3. FIG. 3 is a diagram illustrating a block diagram of the earphone according to the present embodiment. FIG. 3 is a block diagram of each of the pair of left and right earphones 1L and 1R illustrated in FIGS. 1 and 2. A configuration of the earphone 1L of the pair of left and right earphones 1L and 1R will be described below, and a configuration of the earphone 1R is the same as that of the earphone 1L. Therefore, the description of the earphone 1R is similarly omitted in FIG. 3.

A volume control system 100 includes the earphone 1L, the earphone 1R, and a smartphone F1.

The touch sensor TCL is communicably connected to an earphone control unit S2L. The touch sensor TCL outputs a signal related to a touch operation performed by the user to the earphone control unit S2L.

The wearing sensor SEL is communicably connected to the earphone control unit S2L, and outputs a signal related to whether the ear of the user is in contact with the earphone 1L to the earphone control unit S2L.

A power monitoring unit 13L is implemented by, for example, a semiconductor chip. The power monitoring unit 13L includes the battery B1L and measures a remaining charge amount of the battery B1L. The battery B1L is, for example, a lithium ion battery. The power monitoring unit 13L outputs information on the measured remaining charge amount of the battery B1L to the earphone control unit S2L.

A sound signal output control unit S1L and the earphone control unit S2L implement respective functions thereof by using programs and data stored in a ROM 11L which is a read only memory (hereinafter, referred to as “ROM”). The sound signal output control unit S1L and the earphone control unit S2L may use a RAM 12L which is a random access memory (hereinafter, referred to as “RAM”) during operation and temporarily store generated or acquired data or information in the RAM 12L.

The sound signal output control unit S1L is implemented by using, for example, a processor such as a central processing unit (hereinafter, referred to as “CPU”), a micro processing unit (hereinafter, referred to as “MPU”), or a digital signal processor (hereinafter, referred to as “DSP”). The sound signal output control unit S1L is communicably connected to the earphone control unit S2L, and exchanges a sound signal as a digital signal in which the sound signal is converted into a digital format by a pulse code modulation (hereinafter, referred to as “PCM”) method.

The sound signal output control unit S1L executes volume control of a sound to be output to the speaker SP1L based on a control command specifying a volume output from the earphone control unit S2L. The sound signal output control unit S1L adjusts a volume level of a digital signal related to a sound signal acquired from the smartphone F1 to a currently set volume and outputs the digital signal to the speaker SP1L.

The earphone control unit S2L is implemented by using a processor such as a CPU, a MPU, or a DSP, is communicably connected to the sound signal output control unit SIL, the ROM 11L, the RAM 12L, the power monitoring unit 13L, and a wireless communication unit 14L, and exchanges a sound signal as a digital signal in which the sound signal is converted into a digital format by a PCM method. The earphone control unit S2L functions as a controller that controls an overall operation of the earphone 1L, and executes a control process for integrally controlling operations of respective units of the earphone 1L, an input and output process of data with the respective units of the earphone 1L, an arithmetic process of data, and a storage process of data.

The earphone control unit S2L sets a volume upper limit value that can be output from the speaker SP1L based on setting information on a volume upper limit value transmitted from the smartphone F1. The earphone control unit S2L receives a user operation based on a signal output from the touch sensor TCL. The earphone control unit S2L generates a control command to execute the volume control (increase or decrease) of the sound output from the speaker SP1L based on the user operation, and outputs the control command to the sound signal output control unit S1L.

The wireless communication unit 14L wirelessly connects the earphone 1L and the smartphone F1 so as to enable transmission and reception, and receives a sound signal from the smartphone F1. The wireless communication unit 14L includes an antenna ATL and executes short-range wireless communication according to a communication standard of Bluetooth (registered trademark), for example. The wireless communication unit 14L may be provided to be connectable to a communication line such as Wi-Fi (registered trademark) or a mobile communication line. In addition, the earphones 1L and 1R can individually execute wireless communication with the smartphone F1 using the wireless communication unit 14L and a wireless communication unit 14R. Therefore, each of the earphones 1L and IR can receive data, a sound signal, or information transmitted from the smartphone F1.

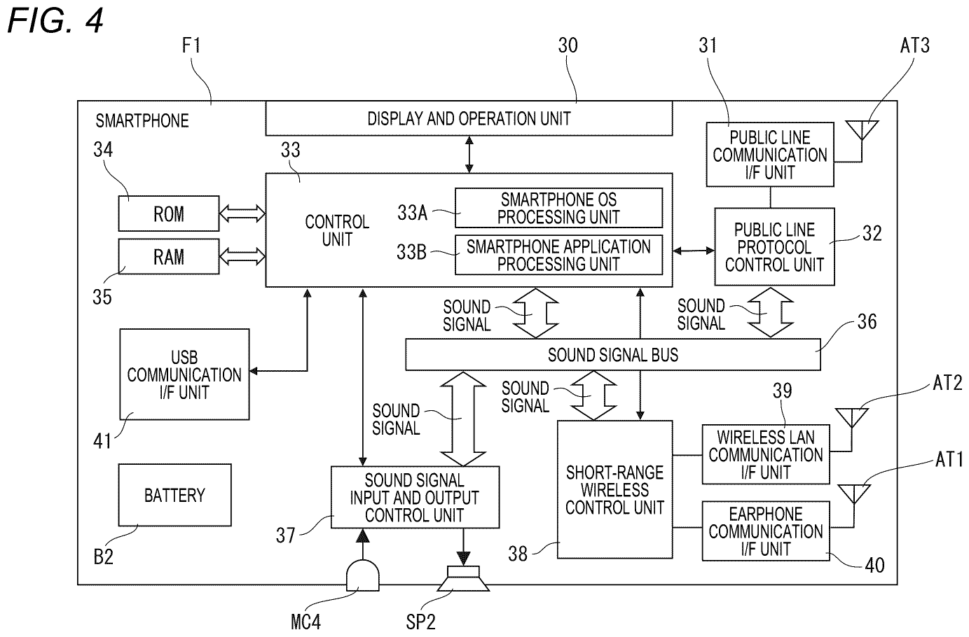

Next, a hardware configuration example of the smartphone F1 will be described using a block diagram of the smartphone F1 with reference to FIG. 4. FIG. 4 is a diagram illustrating the block diagram of the smartphone F1 according to the present embodiment.

The smartphone F1 is a wireless terminal carried by the user. The smartphone F1 includes a display and operation unit 30, a public line communication I/F unit 31, a public line protocol control unit 32, a control unit 33, a ROM 34, a RAM 35, a sound signal bus 36, a sound signal input and output control unit 37, a short-range wireless control unit 38, a wireless LAN communication I/F unit 39, an earphone communication I/F unit 40, a USB communication I/F unit 41, and a battery B2. In FIG. 4, an interface is abbreviated as “I/F”.

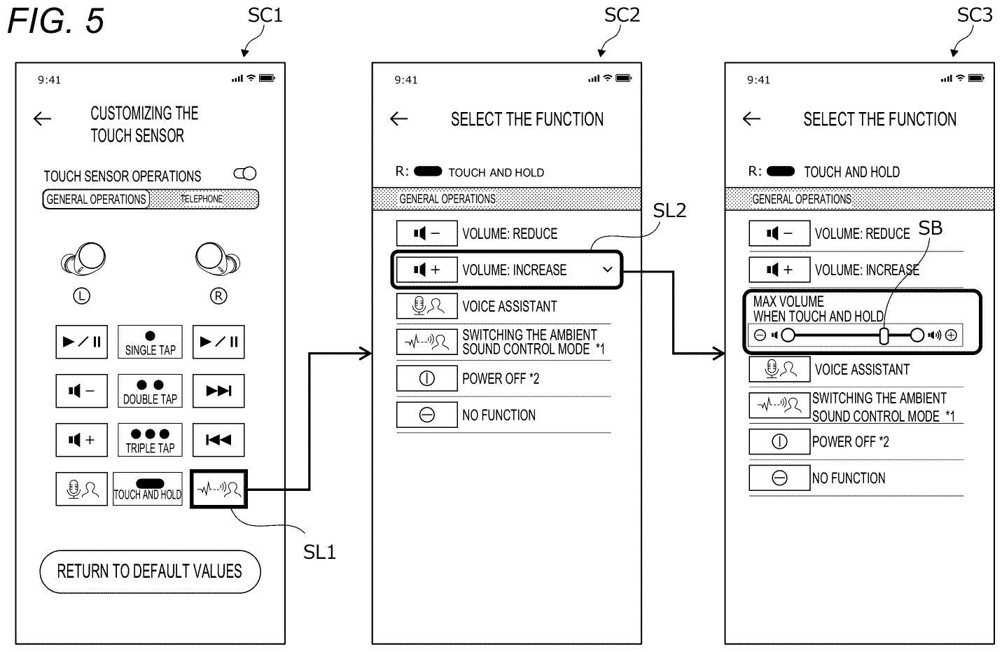

The display and operation unit 30 is implemented by a touch panel and forms a so-called user interface, the touch panel receiving an operation of the user and displaying data generated by the control unit 33. The display and operation unit 30 may display various screens (for example, setting screens SC1, SC2, and SC3 of volume upper limit value illustrated in FIG. 5) generated by the control unit 33. The display and operation unit 30 receives operations of the user on the displayed various screens, generates input signals, and outputs the input signals to the control unit 33.

The public line communication I/F unit 31 is connected to an antenna AT3 provided in the smartphone F1, and executes wireless communication (for example, wireless communication conforming to a fourth generation mobile communication system (4G) or a fifth generation mobile communication system (5G) such as long term evolution (LTE)) with a public base station (not illustrated) using a public line.

The public line communication I/F unit may be omitted from the configuration of the smartphone F1.

The public line protocol control unit 32 executes control related to input and output

of data between the sound signal bus 36 and the public line communication I/F unit 31. The public line protocol control unit 32 may be omitted from the configuration of the smartphone F1.

The control unit 33 is implemented by using, for example, a processor such as a CPU, a MPU, or a DSP. A smartphone OS processing unit 33A and a smartphone application processing unit 33B are functionally provided, and various types of processing and control are executed by cooperation between each of the smartphone OS processing unit 33A and the smartphone application processing unit 33B with the ROM 34. The control unit 33 transmits setting information on the sound volume upper limit value based on the user operation to the earphones 1L and 1R.

A program that defines an operation of the control unit 33 and data used when the program is executed are written in the ROM 34. The ROM 34 respectively stores identification information of the smartphone F1 and identification information of the earphone 1 registered (paired) in advance as a destination to which a sound signal is transmitted.

The RAM 35 is a RAM serving as a work memory used when various types of processing of the control unit 33 are executed. The RAM 35 temporarily stores data or information generated or acquired by the control unit 33.

The sound signal bus 36 inputs and outputs sound signal data to and from the control unit 33, sound signal data to and from the public line protocol control unit 32, sound signal data to and from the sound signal input and output control unit 37, and sound signal data to and from the short-range wireless control unit 38.

Based on a command output from the control unit 33, the sound signal input and output control unit 37 transmits sound signal data picked up by a microphone MC4 to the control unit 33 via the sound signal bus 36, and causes the sound signal input via the sound signal bus 36 to be output from a speaker SP2.

The microphone MC4 picks up a voice based on the utterance of the user who uses the smartphone F1, converts the voice into a sound signal, and transmits the converted sound signal to the sound signal input and output control unit 37. The sound signal picked up by the microphone MC4 is input to the control unit 33 via the sound signal input and output control unit 37 and the sound signal bus 36.

The speaker SP2 acoustically outputs the sound signal data received from the sound signal input and output control unit 37.

The short-range wireless control unit 38 executes control related to input and output of data between the sound signal bus 36 and the wireless LAN communication I/F unit 39 and between the sound signal bus 36 and the earphone communication I/F unit 40. The short-range wireless control unit 38 transmits the command output from the control unit 33 and the data of the sound signal input via the sound signal bus 36 to the wireless LAN communication I/F unit 39 or the earphone communication I/F unit 40. In addition, the short-range wireless control unit 38 may transmit the data of the sound signal input from the wireless LAN communication I/F unit 39 or the earphone communication I/F unit 40 to the control unit 33.

The wireless LAN communication I/F unit 39 is connected to an antenna AT2 provided in the smartphone F1, and executes wireless communication (for example, data transmission from short-range wireless control unit 38) with the earphone 1 by a wireless LAN.

The wireless LAN communication I/F unit 39 is implemented by using a communication circuit connectable to the Internet via a wireless LAN router (not illustrated). In addition, the wireless LAN communication I/F unit 39 may execute wireless communication (for example, wireless LAN such as Wi-Fi (registered trademark)) with each of the earphones 1L and IR via the wireless LAN router (not illustrated) described above.

The earphone communication I/F unit 40 is connected to an antenna AT1 provided in the smartphone F1, and executes short-range wireless communication (for example, data transmission from short-range wireless control unit 38) with the earphone 1 by Bluetooth.

The USB communication I/F unit 41 is an interface for allowing the smartphone F1 and an external device (for example, personal computer (PC)) to communicate with each other in a wired manner such as by a cable.

The USB communication I/F unit 41 is connected to the control unit 33 to enable data communication, and can transmit data from the external device to the control unit 33. In addition, electric charge may be supplied from an external commercial power supply to the battery B2 via the USB communication I/F unit 41.

The battery B2 is a battery (storage battery) capable of storing electric charge supplied from an external commercial power supply, and supplies power to the smartphone F1. The battery B2 may be detachable. The battery B2 may directly receive a supply of power from the external commercial power supply, or may supply power to the smartphone F1 in a state of being disconnected from the external commercial power supply.

Next, a method of setting the volume upper limit value will be described with reference to FIG. 5. FIG. 5 is a diagram illustrating a transition example of the setting screens SC1, SC2, and SC3 of the volume upper limit value. Each of the setting screens SC1, SC2, and SC3 illustrated in FIG. 5 is an example, and the present disclosure is not limited thereto. The control unit 33 of the smartphone F1 generates a customization screen (setting screen SC1) of the touch sensors TCL and TCR based on the user operation, and displays the customization screen on the display and operation unit 30. The setting screen SC1 is a screen capable of receiving setting operations of user operations on the touch sensors TCL and TCR and control of the earphones 1L and 1R to be executed based on contents of the user operations.

In the example illustrated in FIG. 5, in a case where the control unit 33 receives an operation of selecting (pressing) a button SL1 indicating a function assigned to a touch and hold operation on the touch sensor TCR, the control unit 33 generates the setting screen SC2 including a list of functions that can be assigned to the touch and hold operation on the touch sensor TCR, and displays the setting screen SC2 on the display and operation unit 30.

In a case where the control unit 33 receives an operation of selecting (pressing) a button SL2 for a “volume: increase” function of increasing the volume among functions included in the setting screen SC2, the control unit 33 generates the setting screen SC3 on which a volume upper limit value (maximum value) that can be changed by the operation of increasing the volume can be set, and displays the setting screen SC3 on the display and operation unit 30.

The control unit 33 receives a user operation on a seek bar SB, and receives an operation of setting the volume set as the volume upper limit value based on a position of the seek bar SB between a minimum value (indicated by ring mark on left side of seek bar SB) and the maximum value (indicated by ring mark on right side of the seek bar SB) of the volume. The control unit 33 generates a control command to set the volume value corresponding to the position of the seek bar SB to the volume upper limit value, and transmits the control command to the earphone 1.

The earphone control unit S2L and an earphone control unit S2R of the earphone 1 set volume upper limit values that can be increased by the sound signal output control units SIL and SIR based on the control command transmitted from the smartphone F1.

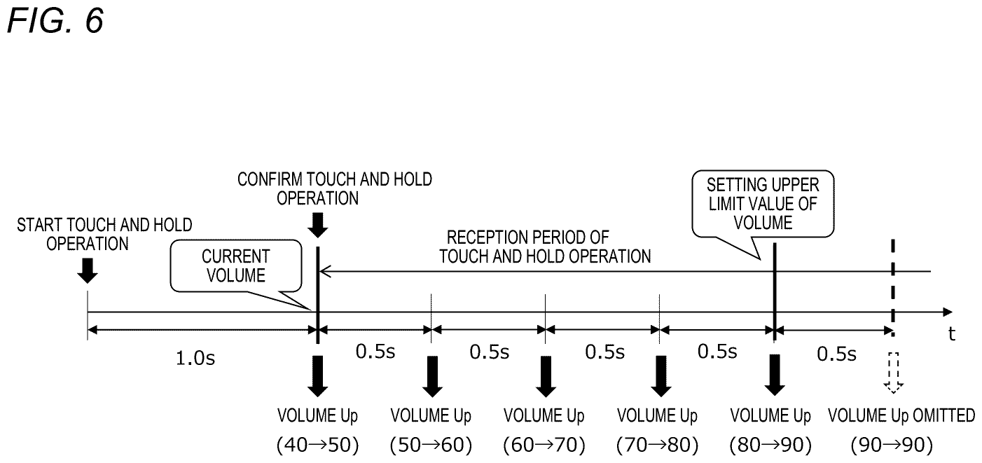

Next, an example of the volume control by the earphone 1 will be described with reference to FIG. 6. FIG. 6 is a diagram illustrating the example of the volume control according to the embodiment. Volume values of “40” to “90” and a time of the touch and hold operation illustrated in FIG. 6 are examples for facilitating the description, and the present disclosure is not limited thereto.

In FIG. 6, as illustrated in the setting screens SC1 to SC3 of FIG. 5, an example in which the function of increasing the volume is set by executing the long-press operation on the touch sensor TCR of the earphone 1R will be described, but the present disclosure is not limited thereto. In FIG. 6, an example in which the volume upper limit value is set to the volume of “90” will be described.

The user starts operating the touch sensor TCR at a timing of “start touch and hold operation” illustrated in FIG. 6. In a case where the earphone 1R continues to detect a touch operation on the touch sensor TCR for 1.0 seconds, the earphone 1R determines that the touch operation is a touch and hold operation, and executes initial volume control of increasing the volume from a currently set volume of “40” to a next largest volume of “50”. The earphone 1R executes volume control of increasing the volume by “10” each time the touch and hold operation is continued for 0.5 seconds after the touch and hold operation is confirmed. The earphone 1R executes the above-described volume control until the touch and hold operation is completed, and stops receiving the operation of increasing the volume when the volume reaches the volume upper limit value of “90” to omit control of increasing the volume.

Accordingly, the earphone 1 can prevent the volume from being adjusted to a volume unintended by the user (that is, volume larger than volume upper limit value), and can protect the ears of the user from an output of the unintended volume. In addition, the earphone 1 can prevent the volume from being adjusted to a volume unintended by the user (that is, volume larger than volume upper limit value) in a case where the user continues the touch and hold operation by mistake.

So far, in a case where the volume is to be adjusted to a volume desired by the user, the user is required to perform, in the touch and hold operation, an operation of releasing the finger from the touch sensor TCR at a timing of switching to the volume desired by the user. However, in a case where the earphone 1 according to the embodiment is used, the user can easily increase the volume to the volume (volume upper limit value) desired by the user only by performing the touch and hold operation by setting the volume upper limit value in advance.

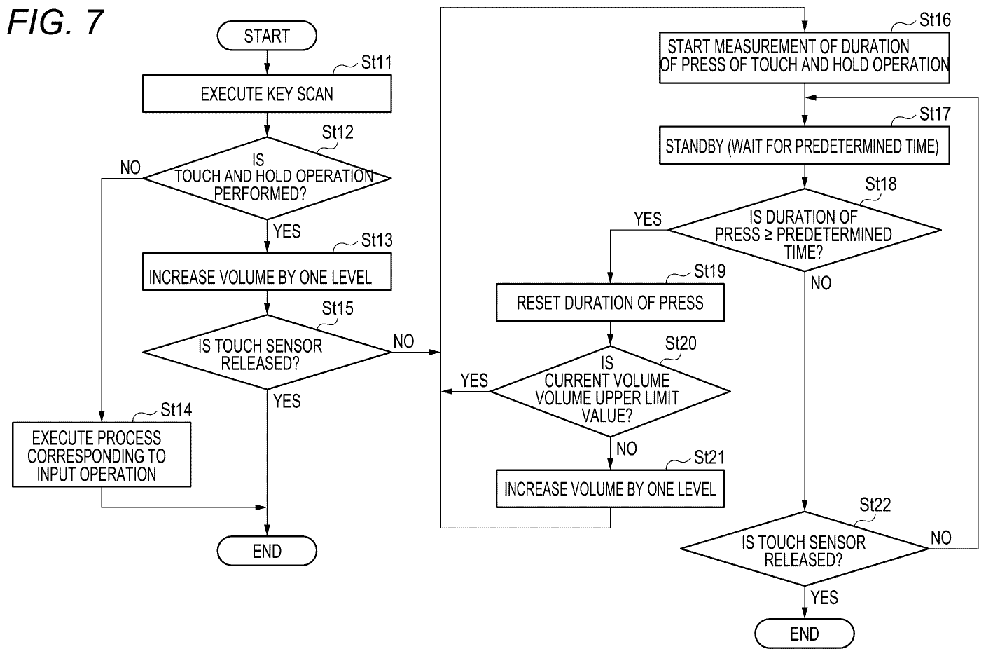

Next, an example of an operation procedure of the earphone 1 according to the embodiment will be described with reference to FIG. 7. FIG. 7 is a flowchart illustrating the example of the operation procedure of the earphone 1 according to the embodiment.

Similarly, in FIG. 7, as illustrated in the setting screens SC1 to SC3 of FIG. 5, an example in which the function of increasing the volume is set by executing the touch and hold operation on the touch sensor TCR of the earphone 1R will be described, but the present disclosure is not limited thereto.

In the description of FIG. 7, an example in which a function of increasing the volume output from the earphone 1 is assigned by the touch and hold operation on the touch sensor TCR of the earphone 1R will be described.

The earphone control unit S2R executes a key scan based on a signal output from the touch sensor TCR (St11). The earphone control unit S2R determines whether the touch and hold operation is performed on the touch sensor TCR as a result of the key scan (St12).

In a case where it is determined that the touch and hold operation is performed in the process of step St12 (YES in St12), the earphone control unit S2R generates a control command to increase the volume output from each of the speakers SP1L and SP1R by one level (for example, from volume of “50” to volume of “60” illustrated in FIG. 6) from the current volume, and outputs the control command to each of the sound signal output control units SIL and SIR (St13).

On the other hand, in a case where it is determined that the touch and hold operation is not performed in the process of step St12 (NO in St12), the earphone control unit S2R executes a process corresponding to an input operation to the touch sensor TCR (St14).

After the volume is increased by one level, the touch and hold operation is completed, and the earphone control unit S2R determines whether the touch sensor TCR is released (St15).

In a case where it is determined that the touch sensor TCR is released in the process of step St15 (YES in St15), the earphone control unit S2R completes a process of increasing the volume.

On the other hand, in a case where it is determined that the touch sensor TCR is not released in the process of step St15 (NO in St15), the earphone control unit S2R starts measuring a duration of press of the touch and hold operation (St16), and shifts to a wait state (that is, state of waiting for predetermined time (several milliseconds or the like)) (St17).

The earphone control unit S2R determines whether the duration of press of the touch and hold operation is equal to or longer than a predetermined time (for example, 0.5 s illustrated in FIG. 6) (St18). A time (example of first predetermined time) for determining in step St12 that the touch and hold operation is performed and a predetermined time (example of second predetermined time) for determining in step St18 whether the touch and hold operation is continued may be the same time or may be times different from each other.

In a case where it is determined that the duration of press of the touch and hold operation is equal to or longer than the predetermined time in the process of step St18 (YES in St18), the earphone control unit S2R resets the measured duration of press (St19), and further determines whether the current volume is the volume upper limit value (St20).

In a case where it is determined that the current volume is the volume upper limit value in the process of step St20 (YES in St20), the earphone control unit S2R omits the process of increasing the volume and proceeds to the process of step St16.

On the other hand, in a case where it is determined that the current volume is not the volume upper limit value in the process of step St20 (NO in St20), the earphone control unit S2R generates a control command to increase the volume output from each of the speakers SP1L and SP1R by one level from the current volume, outputs the control command to each of the sound signal output control units S1L and S1R (St21), and returns to the process of step St16.

On the other hand, in a case where it is determined that the duration of press of the touch and hold operation is not equal to or longer than the predetermined time in the process of step St18 (NO in St18), the earphone control unit S2R further determines whether the touch sensor TCR is released (St22).

In a case where it is determined that the touch sensor TCR is released in the process

of step St22 (YES in St22), the earphone control unit S2R completes the process of increasing the volume.

On the other hand, in a case where it is determined that the touch sensor TCR is not released in the process of step St22 (NO in St22), the earphone control unit S2R returns to the process of step St17.

Accordingly, the earphone 1 can prevent the volume from being adjusted to a volume unintended by the user (that is, volume larger than volume upper limit value), and can protect the ears of the user from an output of the unintended volume. In addition, the earphone 1 can prevent the volume from being adjusted to a volume unintended by the user (that is, volume larger than volume upper limit value) in a case where the user continues the touch and hold operation by mistake.

### Note

The following techniques are disclosed based on the above description of the embodiments.

### Technique 1

A volume control system 100 including:
two earphones 1L and 1R each having an input unit (touch sensors TCL and TCR) capable of receiving a user operation; and
a wireless terminal (smartphone F1) capable of communicating with the earphones 1L and 1R, in which
the wireless terminal is configured to
   receive an operation of inputting a volume upper limit value of the earphones 1L and 1R and transmit the volume upper limit value to the earphones 1L and IR, and
the earphones 1L and 1R are configured to
   store the volume upper limit value,
   increase a current volume in a case where it is determined that the current volume is not the volume upper limit value based on reception of a first continuous operation in which the user operation by the input unit (touch sensors TCL and TCR) is continued for a first predetermined time (for example, 1.0 s illustrated in FIG. 6) or longer,
   determine whether a second continuous operation in which the user operation by the input unit (touch sensors TCL and TCR) is continued for a second predetermined time (for example, 0.5 s illustrated in FIG. 6) or longer is received following the first continuous operation,
   further determine whether a current volume is the volume upper limit value in a case where it is determined that the second continuous operation is received,
   increase the current volume in a case where it is determined that the current volume is not the volume upper limit value, and
   omit a process of increasing the current volume in a case where it is determined that the current volume is the volume upper limit value.

With this configuration, the sound volume control system 100 can prevent the volume from being adjusted to a volume unintended by the user (that is, volume larger than volume upper limit value), and can protect the ears of the user from an output of the unintended volume. In addition, the earphone 1 can prevent the volume from being adjusted to a volume unintended by the user (that is, volume larger than volume upper limit value) in a case where the user continues the touch and hold operation by mistake.

### Technique 2

The volume control system 100 according to (technique 1), in which
the earphones 1L and 1R are configured to
   start measurement of a duration of the user operation after the second continuous operation in a case where it is determined that the user operation to the input unit is performed after the second continuous operation is received, and
   receive the second continuous operation again in a case where it is determined that the measured duration is equal to or longer than the second predetermined time.

With this configuration, in a case where the user continues the touch and hold operation, the volume control system 100 can continuously execute the control of increasing the volume with the sound volume upper limit value as the upper limit.

### Technique 3

The volume control system 100 according to (technique 1) or (technique 2), in which
the earphones 1L and 1R are configured to
   start measurement of a duration of the user operation after the first continuous operation in a case where it is determined that the user operation to the input unit is performed after the first continuous operation is received, and
   receive the second continuous operation in a case where it is determined that the measured duration is equal to or longer than the second predetermined time.

With this configuration, in a case where the user continues the touch and hold operation, the volume control system 100 can continuously execute the control of increasing the volume with the sound volume upper limit value as the upper limit.

### Technique 4

A volume control method executed by a system (volume control system 100), the system including two earphones 1L and 1R each having an input unit (touch sensors TCL and TCR) capable of receiving a user operation and a wireless terminal (smartphone F1) capable of communicating with the earphones 1L and 1R, the volume control method including:
receiving an operation of inputting a volume upper limit value of the earphones 1L and 1R and storing the volume upper limit value;
increasing a current volume in a case where it is determined that the current volume is not the volume upper limit value based on reception of a first continuous operation in which the user operation by the input unit (touch sensors TCL and TCR) is continued for a first predetermined time (for example, 1.0 s illustrated in FIG. 6) or longer;
determining whether a second continuous operation in which the user operation by the input unit (touch sensors TCL and TCR) is continued for a second predetermined time (for example, 0.5 s illustrated in FIG. 6) or longer is received following the first continuous operation;
further determining whether a current volume is the volume upper limit value in a case where it is determined that the second continuous operation is received;
increasing the current volume in a case where it is determined that the current volume is not the volume upper limit value; and
omitting a process of increasing the current volume in a case where it is determined that the current volume is the volume upper limit value.

With this configuration, the sound volume control system 100 can prevent the volume from being adjusted to a volume unintended by the user (that is, volume larger than volume upper limit value), and can protect the ears of the user from an output of the unintended volume. In addition, the earphone 1 can prevent the volume from being adjusted to a volume unintended by the user (that is, volume larger than volume upper limit value) in a case where the user continues the touch and hold operation by mistake.

Although the embodiments have been described above with reference to the accompanying drawings, the present disclosure is not limited to such an example. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

### INDUSTRIAL APPLICABILITY

The present disclosure is useful for providing a volume control system and a volume control method that more effectively prevents an output of a high volume unintended by a user.

What is claimed is:

1. A volume control system comprising:
two earphones each having an input unit capable of receiving a user operation; and
a wireless terminal capable of communicating with the earphones, wherein
the wireless terminal is configured to
receive an operation of inputting a volume upper limit value of the earphones and transmits the volume upper limit value to the earphones, and
the earphone is configured to
store the volume upper limit value,
increase a current volume in a case where it is determined that the current volume is not the volume upper limit value based on reception of a first continuous operation in which the user operation by the input unit is continued for a first predetermined time or longer,
determine whether a second continuous operation in which the user operation by the input unit is continued for a second predetermined time or longer is received following the first continuous operation,
further determine whether a current volume is the volume upper limit value in a case where it is determined that the second continuous operation is received,
increase the current volume in a case where it is determined that the current volume is not the volume upper limit value, and
omit a process of increasing the current volume in a case where it is determined that the current volume is the volume upper limit value.

2. The volume control system according to claim 1, wherein the earphone is configured to
start measurement of a duration of the user operation after the second continuous operation in a case where it is determined that the user operation to the input unit is performed after the second continuous operation is received, and
receive the second continuous operation again in a case where it is determined that the measured duration is equal to or longer than the second predetermined time.

3. The volume control system according to claim 1, wherein the earphone is configured to
start measurement of a duration of the user operation after the first continuous operation in a case where it is determined that the user operation to the input unit is performed after the first continuous operation is received, and
receive the second continuous operation in a case where it is determined that the measured duration is equal to or longer than the second predetermined time.

4. A volume control method executed by a system, the system including two earphones each having an input unit capable of receiving a user operation and a wireless terminal capable of communicating with the earphones, the volume control method comprising:
receiving an operation of inputting a volume upper limit value of the earphones and storing the volume upper limit value;
increasing a current volume in a case where it is determined that the current volume is not the volume upper limit value based on reception of a first continuous operation in which the user operation by the input unit is continued for a first predetermined time or longer;
determining whether a second continuous operation in which the user operation by the input unit is continued for a second predetermined time or longer is received following the first continuous operation;
further determining whether a current volume is the volume upper limit value in a case where it is determined that the second continuous operation is received;
increasing the current volume in a case where it is determined that the current volume is not the volume upper limit value; and
omitting a process of increasing the current volume in a case where it is determined that the current volume is the volume upper limit value.
